(19) United States
(12) Patent Application Publication
(10) Pub. No.: US 2013/0243305 A1
(43) Pub. Date: Sep. 19, 2013

(54) IMAGE PROCESSING METHOD FOR STEREOSCOPIC IMAGES

(71) Applicants: Chun-Chieh Chiu, Taoyuan County (TW); Hsiang-Tan Lin, Keelung City (TW); Chien-Hung Chen, New Taipei City (TW)

(72) Inventors: Chun-Chieh Chiu, Taoyuan County (TW); Hsiang-Tan Lin, Keelung City (TW); Chien-Hung Chen, New Taipei City (TW)

(21) Appl. No.: 13/532,763

(22) Filed: Jun. 25, 2012

(30) Foreign Application Priority Data
Mar. 19, 2012 (TW) 101109319

(51) Int. Cl. G06K 9/36

(52) U.S. Cl. 382/154

(57) ABSTRACT

An image processing method for stereoscopic images includes providing image data of a first visual angle image and image data of a second visual angle image; performing first image processing to the image data of the second visual angle image according to performance of a first display parameter of the image data of the first visual angle image on a display panel, for adjusting performance of the first display parameter of the image data of the second visual angle image on the display panel to correspond to the performance of the first display parameter of the image data of the first visual image on the display panel; and displaying the first visual angle image and the second visual angle image after the first image processing.

### BACKGROUND OF THE INVENTION

1. Field of the Invention

The present invention relates to an image processing method, and more particularly, to an image processing method for stereoscopic images.

2. Description of the Prior Art

As related technology keeps improving, functions of a display device are getting more powerful. Besides displaying images, current display devices can be utilized for surfing the Internet, and making free Internet calls, etc. In order to satisfy entertainment demands of consumers, some display devices is capable of displaying stereoscopic images. A 3D display device displays left visual angle images and right visual angle images on a display panel, such that a left eye and a right eye of a user can see the left visual angle images and the right visual angle images respectively, in order to generate a stereoscopic effect.

Generally, there are two kinds of methods for displaying the left visual angle image and the right visual angle image by the 3D display device. In one method, the display panel displays the left visual angle image and the right visual angle image simultaneously, and utilizes an optical polarization component for arranging a polarization direction of the left visual angle image to be different from a polarization direction of the right visual angle image, and the left eye and the right eye of the user can see the left visual angle image and the right visual angle image respectively through a pair of polarized glasses. In another method, the display panel displays the left visual angle image and the right visual angle image sequentially, and the left eye and the right eye of the user can see the left visual angle image and the right visual angle image respectively through a pair of shutter glasses, which shutter a left glass and a right glass sequentially.

However, due to issues of light leakage or difference of polarization directions of the 3D glasses, there are differences in color, brightness, and color temperature between the left visual angle image and the right visual angle image seen by the user, such that affects image quality of the stereoscopic images displayed on the 3D display devices.

### SUMMARY OF THE INVENTION

The present invention provides an image processing method for stereoscopic images. The image processing method comprises providing image data of a first visual angle image and image data of a second visual angle image; performing first image processing to the image data of the second visual angle image according to performance of a first display parameter of the image data of the first visual angle image on a display panel, for adjusting performance of the first display parameter of the image data of the second visual angle image on the display panel to correspond to the performance of the first display parameter of the image data of the first visual image on the display panel; and displaying the first visual angle image and the second visual angle image after the first image processing.

Compared with the prior art, the image processing method for stereoscopic images of the present invention can perform image processing to the left visual angle image and/or the right visual angle image, in order to make the color, brightness, and color temperature of the left visual angle images and the right visual angle image consistent with each other, so as to further improve the image quality of the stereoscopic images.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a first embodiment of an image processing method for stereoscopic images of the present invention.

FIG. 2 is a diagram illustrating a second embodiment of the image processing method for stereoscopic images of the present invention.

FIG. 3 is a diagram illustrating a third embodiment of the image processing method for stereoscopic images of the present invention.

FIG. 4 is a diagram illustrating a fourth embodiment of the image processing method for stereoscopic images of the present invention.

FIG. 5 is a diagram illustrating a fifth embodiment of the image processing method for stereoscopic images of the present invention.

FIG. 6 is a flowchart showing the image processing method for stereoscopic images of the present invention.

### DETAILED DESCRIPTION

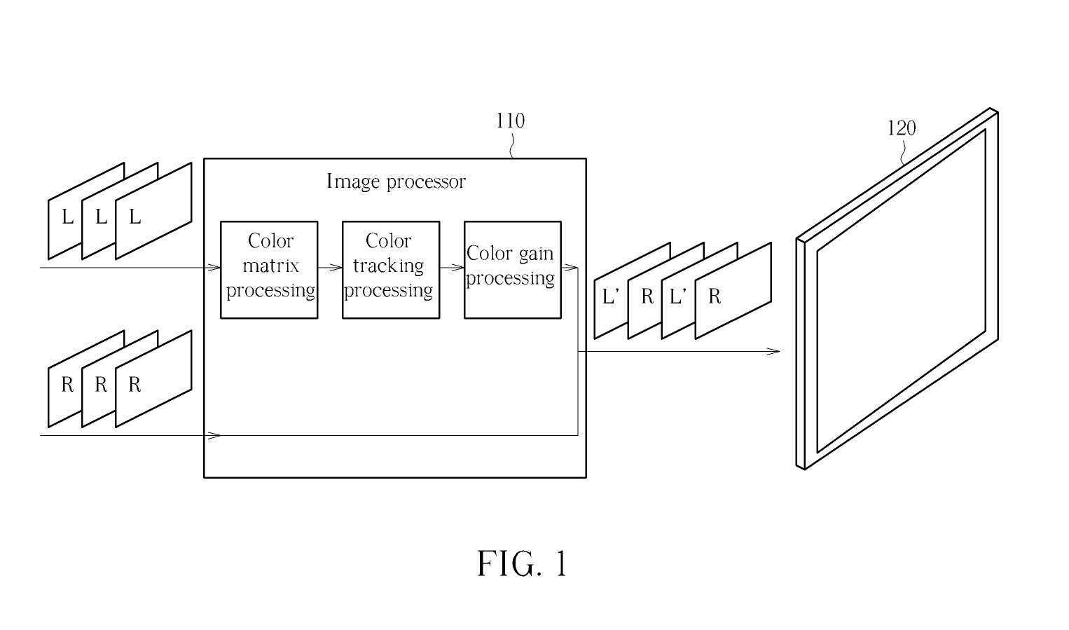

Please refer to FIG. 1. FIG. 1 is a diagram illustrating a first embodiment of an image processing method for stereoscopic images of the present invention. As shown in FIG. 1, after receiving image data of first visual angle images R and image data of second visual angle images L, an image processor 110 is utilized for performing image processing to the second visual angle images L, and a display panel then sequentially displays the first visual angle images R and the second visual angle images L′ after the first image processing in different periods. In order to solve the problem of differences in color, brightness, and color temperature between left visual angle images and right visual angle images caused by 3D glasses, the image processor 110 can perform image processing to the image data of the second visual angle images L according to performance of the image data of the first visual angle image R on the display panel 120, for adjusting performance of a display parameter of the image data of the second visual angle image L′ on the display panel 120 to correspond to the performance of the display parameter of the image data of the first visual image R on the display panel 120.

For example, color gamut of the first visual angle image R may be different from color gamut of the second visual image L due to the 3D glasses, such that colors of an object in the first visual angle image R is different from colors of the object in the second visual angle image L to the user. Therefore, the image processor 110 can perform color matrix processing to the image data of the second visual angle image L according to performance of a color gamut parameter of the image data of the first visual angle image on the display panel 120, for adjusting performance of the color gamut parameter of the image data of the second visual angle image L′ on the display panel 120 to correspond to the performance of the color gamut parameter of the image data of the first visual image R on the display panel 120, in order to make the colors of the object in the first visual angle image R consistent with the colors of the object in the second visual angle image L to the user.

In addition, a gray level curve of the first visual angle image R may be different from a gray level curve of the second visual image L due to the 3D glasses, such that brightness of an object in the first visual angle image R is different from brightness of the object in the second visual angle image L to the user. Therefore, the image processor 110 can perform color tracking processing to the image data of the second visual angle image L according to performance of a gray level parameter of the image data of the first visual angle image R on the display panel 120, for adjusting performance of the gray level parameter of the image data of the second visual angle image L′ on the display panel 120 to correspond to the performance of the gray level parameter of the image data of the first visual image R on the display panel 120, in order to make the brightness of the object in the first visual angle image R consistent with the brightness of the object in the second visual angle image L to the user. Moreover, after performing the color tracking processing to the second visual angle image L, performance of white color temperature of the second visual angle image L′ at each gray level on the display panel 120 can be consistent.

On the other hand, color temperature of the first visual angle image R may be different from color temperature of the second visual image L due to the 3D glasses, such that color temperature of an object in the first visual angle image R is different from color temperature of the object in the second visual angle image L to the user. Therefore, the image processor 110 can perform color gain processing to the image data of the second visual angle image L according to performance of a color temperature parameter of the image data of the first visual angle image on the display panel 120, for adjusting performance of the color temperature parameter of the image data of the second visual angle image L′ on the display panel 120 to correspond to the performance of the color temperature parameter of the image data of the first visual image R on the display panel 120, in order to make the color temperature of the object in the first visual angle image R consistent with the color temperature of the object in the second visual angle image L to the user.

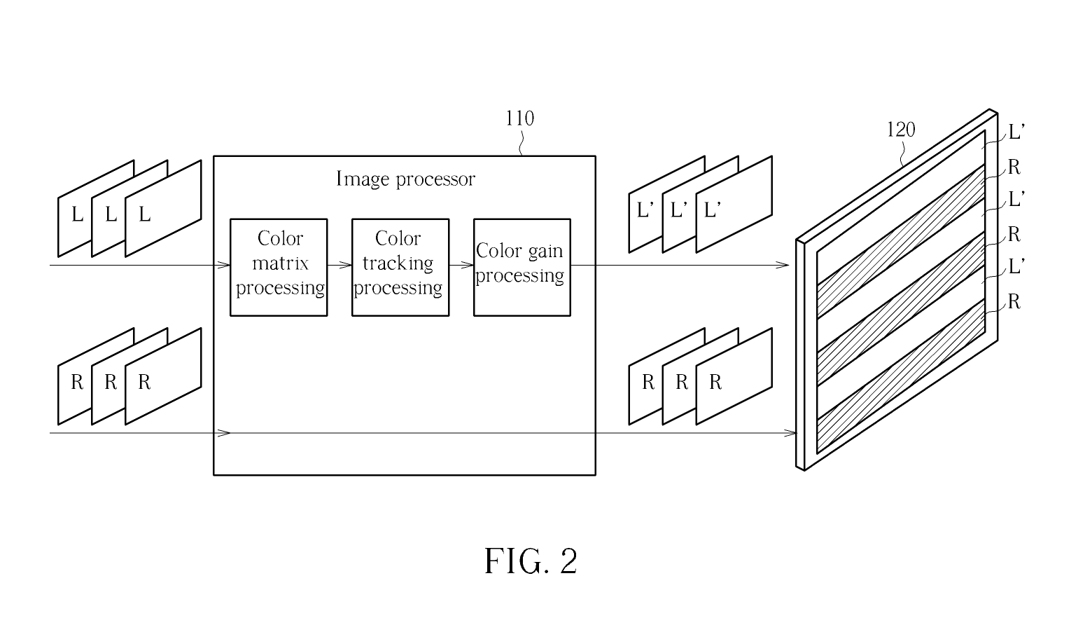

Please refer to FIG. 2. FIG. 2 is a diagram illustrating a second embodiment of the image processing method for stereoscopic images of the present invention. As shown in FIG. 2, after receiving the image data of the first visual angle images R and the image data of the second visual angle images L, the image processor 110 is utilized for performing image processing to the second visual angle images L, for example, the image processor 110 can perform the color matrix processing, the color tracking processing, and the color gain processing to the second visual angle images L according to performance of the display parameters of the image data of the first visual angle image R on the display panel 120, and the display panel 120 then simultaneously displays the first visual angle images R and the second visual angle images L′ after the first image processing.

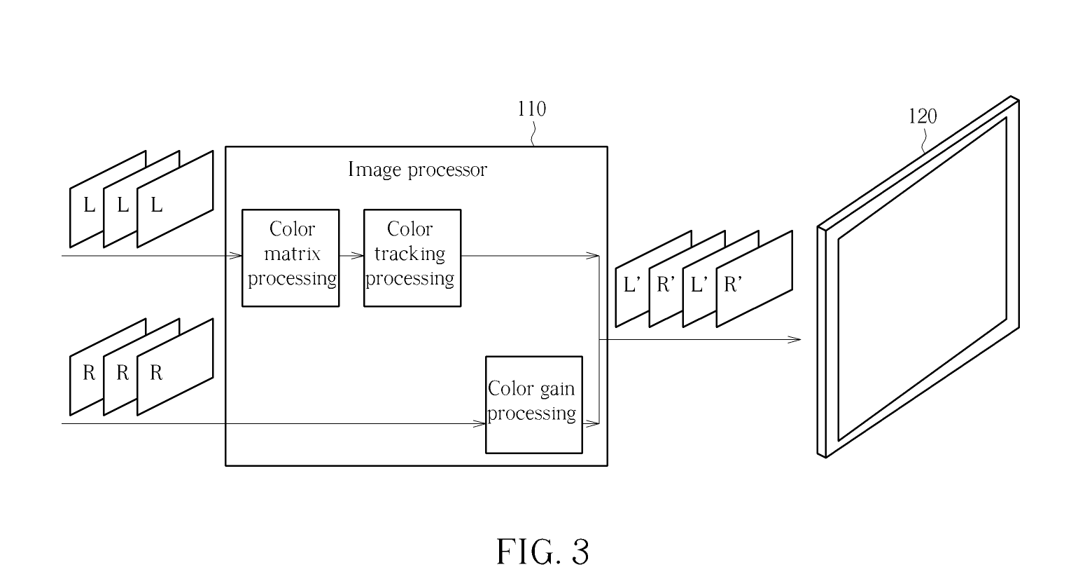

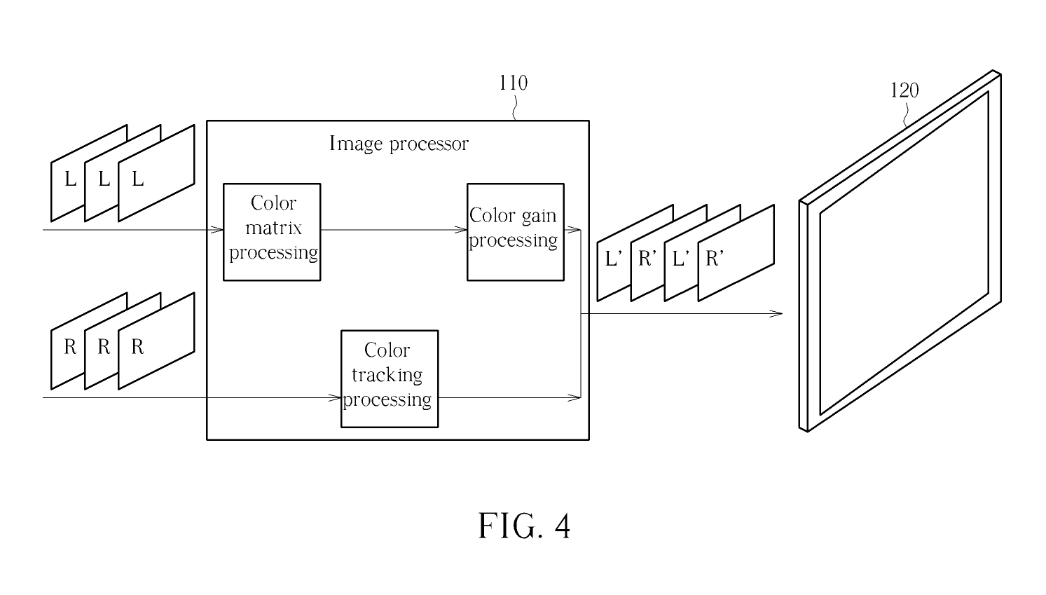

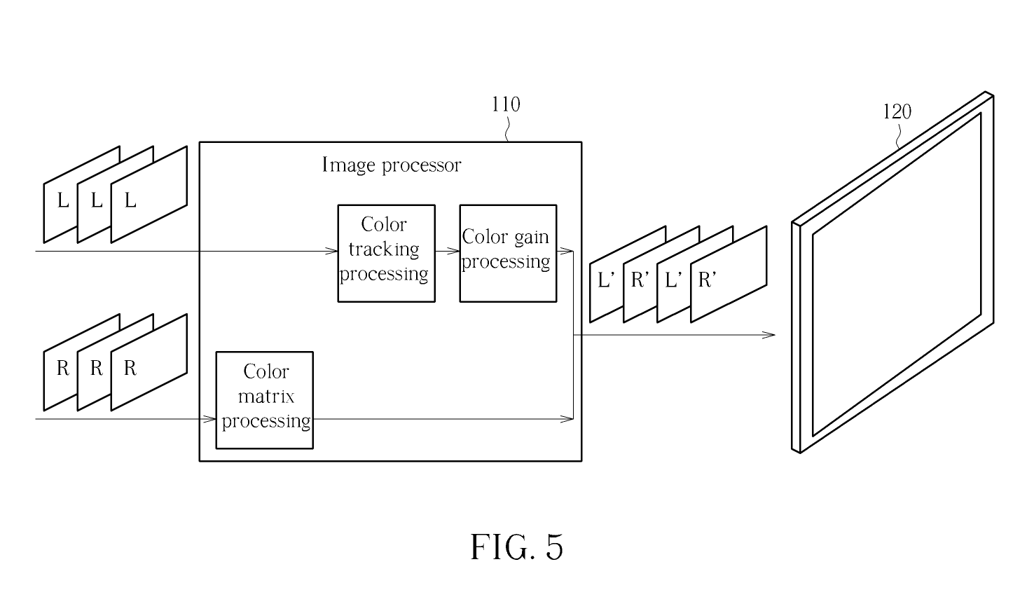

Please refer to FIG. 3 to FIG. 5 together. FIG. 3 is a diagram illustrating a third embodiment of the image processing method for stereoscopic images of the present invention. FIG. 4 is a diagram illustrating a fourth embodiment of the image processing method for stereoscopic images of the present invention. FIG. 5 is a diagram illustrating a fifth embodiment of the image processing method for stereoscopic images of the present invention. After receiving the image data of the first visual angle images R and the image data of the second visual angle images L, the image processor 110 can respectively perform image processing to the first visual angle images R and the second visual angle images L. For example, as shown in FIG. 3, the image processor 110 can perform the color matrix processing and the color tracking processing to the image data of the second visual angle image L according to the performance of the color gamut parameter and the gray level parameter of the image data of the first visual angle image R on the display panel 120, and the image processor 110 can further perform the color gain processing to the image data of the first visual angle image R according to the performance of the color temperature parameter of the image data of the second visual angle image L on the display panel 120, the display panel then displays the first visual angle image R′ after the image processing and the second visual angle image L′ after the image processing; or, as shown in FIG. 4, the image processor 110 can perform the color matrix processing and the color gain processing to the image data of the second visual angle image L according to the performance of the color gamut parameter and the color temperature parameter of the image data of the first visual angle image R on the display panel 120, and the image processor 110 can further perform the color tracking processing to the image data of the first visual angle image R according to the performance of the gray level parameter of the image data of the second visual angle image L on the display panel 120, the display panel then displays the first visual angle image R′ after the image processing and the second visual angle image L′ after the image processing; or, as shown in FIG. 5, the image processor 110 can perform the color tracking processing and the color gain processing to the image data of the second visual angle image L according to the performance of the gray level parameter and the color temperature parameter of the image data of the first visual angle image R on the display panel 120, and the image processor 110 can further perform the color matrix processing to the image data of the first visual angle image R according to the performance of the color gamut parameter of the image data of the second visual angle image L on the display panel 120, the display panel then displays the first visual angle image R′ after the image processing and the second visual angle image L′ after the image processing. According to the above arrangement, performance of color, brightness, and color temperature of the object in the first visual angle image R′ and the second visual angle image L′ seen by the user can be consistent with each other.

In the above embodiments, the first visual angle image is a right visual angle image, and the second visual angle image is a left visual angle image. However, in other embodiments of the present invention, the first visual angle image can be a left visual angle image, and the second visual angle image can be a right visual angle image.

In addition, the image processor 110 can perform the image processing to the first visual angle image R and the second visual angle image L according to a look-up table, such that when the image processor 110 receives the image data of the first visual angle image R and the second visual angle image L, the image processor 110 can instantly adjust the display parameters of the first visual angle image R and/or the second visual angle image L according to the look-up table

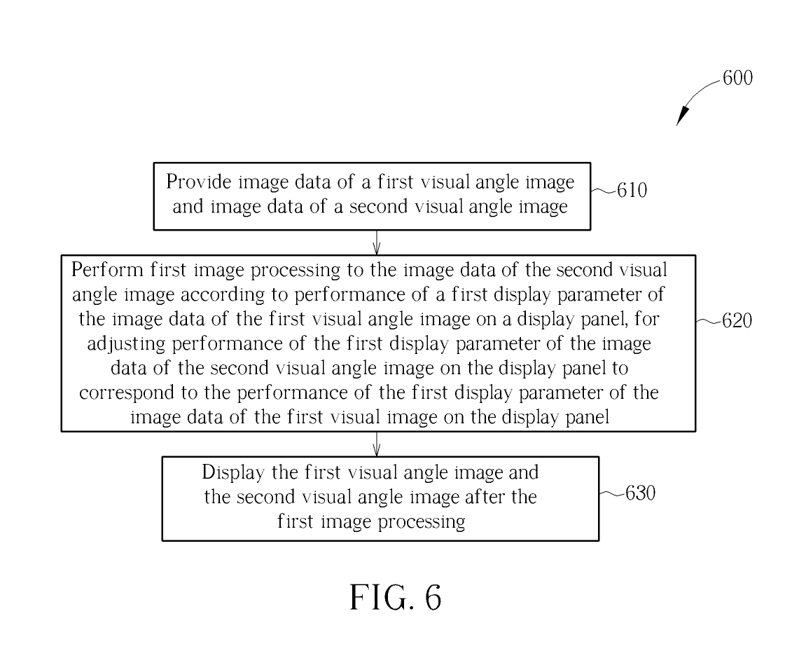

Please refer to FIG. 6. FIG. 6 is a flowchart 600 showing the image processing method for stereoscopic images of the present invention. The image processing method for stereoscopic images of the present invention comprises the following steps:

Step 610: Provide image data of a first visual angle image and image data of a second visual angle image;

Step 620: Perform first image processing to the image data of the second visual angle image according to performance of a first display parameter of the image data of the first visual angle image on a display panel, for adjusting performance of the first display parameter of the image data of the second visual angle image on the display panel to correspond to the performance of the first display parameter of the image data of the first visual image on the display panel; and

Step 630: Display the first visual angle image and the second visual angle image after the first image processing.

Compared with the prior art, the image processing method for stereoscopic images of the present invention can perform image processing to the left visual angle image and/or the right visual angle image, in order to make the color, brightness, and color temperature of the left visual angle images and the right visual angle image consistent with each other, so as to further improve the image quality of the stereoscopic images.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image processing method for stereoscopic images, comprising:
providing image data of a first visual angle image and image data of a second visual angle image;
performing first image processing to the image data of the second visual angle image according to performance of a first display parameter of the image data of the first visual angle image on a display panel, for adjusting performance of the first display parameter of the image data of the second visual angle image on the display panel to correspond to the performance of the first display parameter of the image data of the first visual image on the display panel; and
displaying the first visual angle image and the second visual angle image after the first image processing.

2. The method of claim 1, wherein performing the first image processing to the image data of the second visual angle image according to performance of the first display parameter of the image data of the first visual angle image on the display panel, comprises performing color matrix processing to the image data of the second visual angle image according to performance of a color gamut parameter of the image data of the first visual angle image on the display panel.

3. The method of claim 1, wherein performing the first image processing to the image data of the second visual angle image according to performance of the first display parameter of the image data of the first visual angle image on the display panel, comprises performing color tracking processing to the image data of the second visual angle image according to performance of a gray level parameter of the image data of the first visual angle image on the display panel.

4. The method of claim 1, wherein performing the first image processing to the image data of the second visual angle image according to performance of the first display parameter of the image data of the first visual angle image on the display panel, comprises performing color gain processing to the image data of the second visual angle image according to performance of a color temperature parameter of the image data of the first visual angle image on the display panel.

5. The method of claim 1 further comprising:
performing second image processing to the image data of the first visual angle image according to performance of a second display parameter of the image data of the second visual angle image on the display panel, for adjusting performance of the second display parameter of the image data of the first visual angle image on the display panel to correspond to the performance of the second display parameter of the image data of the second visual image on the display panel;
wherein displaying the first visual angle image and the second visual angle image after the first image processing is displaying the first visual angle image after the second image processing and the second visual angle image after the first image processing.

6. The method of claim 5, wherein performing the first image processing to the image data of the second visual angle image according to the performance of the first display parameter of the image data of the first visual angle image on the display panel comprises:
performing color matrix processing to the image data of the second visual angle image according to performance of a color gamut parameter of the image data of the first visual angle image on the display panel; and
performing color tracking processing to the image data of the second visual angle image according to performance of a gray level parameter of the image data of the first visual angle image on the display panel; and
wherein performing second image processing to the image data of the first visual angle image according to performance of a second display parameter of the image data of the second visual angle image on the display panel, comprises performing color gain processing to the image data of the first visual angle image according to performance of a color temperature parameter of the image data of the second visual angle image on the display panel.

7. The method of claim 5, wherein performing the first image processing to the image data of the second visual angle image according to the performance of the first display parameter of the image data of the first visual angle image on the display panel comprises:
performing color matrix processing to the image data of the second visual angle image according to performance of a color gamut parameter of the image data of the first visual angle image on the display panel; and
performing color gain processing to the image data of the second visual angle image according to performance of a color temperature parameter of the image data of the first visual angle image on the display panel; and
wherein performing second image processing to the image data of the first visual angle image according to performance of a second display parameter of the image data of the second visual angle image on the display panel, comprises performing color tracking processing to the image data of the first visual angle image according to performance of a gray level parameter of the image data of the second visual angle image on the display panel.

8. The method of claim 5, wherein performing the first image processing to the image data of the second visual angle image according to the performance of the first display parameter of the image data of the first visual angle image on the display panel comprises:
performing color tracking processing to the image data of the second visual angle image according to performance of a gray level parameter of the image data of the first visual angle image on the display panel; and
performing color gain processing to the image data of the second visual angle image according to performance of a color temperature parameter of the image data of the first visual angle image on the display panel; and
wherein performing second image processing to the image data of the first visual angle image according to performance of a second display parameter of the image data of the second visual angle image on the display panel, comprises performing color matrix processing to the image data of the first visual angle image according to performance of a color gamut parameter of the image data of the second visual angle image on the display panel.

9. The method of claim 1, wherein displaying the first visual angle image and the second visual angle image after the first image processing is simultaneously displaying the first visual angle image and the second visual angle image after the first image processing.

10. The method of claim 1, wherein displaying the first visual angle image and the second visual angle image after the first image processing is displaying the first visual angle image in a first period and displaying the second visual angle image after the first image processing in a second period.
